(19) United States
(12) Patent Application Publication
(10) Pub. No.: US 2004/0109931 A1
(43) Pub. Date: Jun. 10, 2004

(54) Reconstituted grain product

(76) Inventors: Jiing-Yang Wu, Hsinchu (TW); Lin-Shyang Tzeng, Hsinchu (TW); I-Chin Wang, Hsinchu (TW); Chin-Hung Chang, Hsinchu (TW); Bao-Hung Huang, Hsinchu (TW)

Correspondence Address: FISH & RICHARDSON PC, 225 FRANKLIN ST, BOSTON, MA, 02110, US

(21) Appl. No.: 10/634,170

(22) Filed: Aug. 5, 2003

(30) Foreign Application Priority Data
Dec. 4, 2002 (TW) 91135206

(51) Int. Cl. A23L 1/168

(52) U.S. Cl. 426/615

(57) ABSTRACT

A reconstituted grain product. The reconstituted grain product consists of a ground material including a plurality of grains and legumes. The grains and legumes have various respective cooking requirements.

### BACKGROUND OF THE INVENTION

1. Field of the Invention

The present invention relates to a reconstituted grain product. More particularly, the present invention relates to a reconstituted grain product comprising ground cereal grains and legumes.

2. Description of the Related Arts

From ancient times to the present, cereal grains have been a primary food source for human beings. Recently, scientific studies on the functions or properties of cereal grains and legumes strengthen their importance for human health. Since different cereal grains and legumes have various physical and chemical properties, their water-absorption can be diverse. Overnight pre-cooking soaking in water may be necessary for some cereal grains and legumes. In addition, cooking requirements for different cereal grains and legumes are distinct, and the quality, such as softness and edibility, of the cooked mixture of cereal grains and legumes are inconsistent. Therefore, it is often inconvenient or less than enjoyable eat cooked mixtures of cereal grains and legumes.

U.S. Pat. No. 4,769,251 proposed by Wenger discloses a low shear process for the production of quick cooking rice products. In this process, a mixture containing 60˜80% by weight of rice material selected from rice flour and rice granules and mixtures thereof and 20˜40% by weight of water are prepared in a preconditioner. The mixture retained in the preconditioner is then partially cooked by elevating the temperature of the mixture to 65.5° C.˜98.8° C. for 20 seconds to 3 minutes. After that, the partially cooked mixture is introduced into a barrel of an extruder. The extruder has a cooking zone, a venting zone, a forming zone, and an extrusion die. The partially cooked mixture is sequentially passed through the cooking zone, the venting zone, the forming zone, and the extrusion die to yield an extruded product. The partially cooked mixture is retained at 82.2° C.˜148.8° C. for 10 to 25 seconds in the cooking zone. After vacuum treatment in the venting zone, the mixture is retained at 54.4° C.˜121° C. for 20 to 60 seconds and subjected to pressures of 200˜1200 psig in the forming zone. Finally, the extruded product is dried at 23.8° C.˜121° C. for 20 to 60 seconds to yield quick cooking rice products. The quick cooking rice products are edible after immersing in boiling water or hot water for 5 to 10 minutes.

The above mentioned process for the quick cooking rice products is complicated, including multiple steps. In addition, special equipment such as a vacuum is required, presenting inconvenience for general processing. Moreover, the ingredients of the quick cooking rice products merely include rice flour and rice granules, limiting the nutritional value. There is, therefore, still a need to improve the process and the product.

### SUMMARY OF THE INVENTION

It is therefore a primary object of the present invention to provide a convenient, high-quality, reconstituted grain product and the preparation thereof. The reconstituted grain product is easy to cook and has consistent softness, springiness, and moistness after cooking.

In one aspect of the present invention, the reconstituted grain product comprises a plurality of grains and legumes, wherein the grains and legumes have various respective cooking requirements.

The ground material of the reconstituted grain product in the present invention is between 80˜200 meshes, preferably 100˜200 meshes.

In one preferred embodiment, the grains include, but are not limited to, rice, barley, oat, buckwheat, adlay, millet, sorghum, sweet corn, wheat, rye, brown rice or bran; rice includes non-glutinous long-grain indica, non-glutinous short-grain japonica and glutinous rice. Among these, rice is about 10˜90% by weight of the ground material, preferably about 25% by weight. Barley, oat, buckwheat, adlay, millet, sorghum, sweet corn, wheat, or rye is 1˜50% by weight of the ground material respectively. Preferably, barley is about 17.5% by weight of the ground material, oats is about 17.5% by weight, buckwheat is 17.5% by weight, adlay is 17.5% by weight. Rice bran is 1˜10% by weight of the ground material, preferably about 5% by weight. The legumes in the present invention include, but are not limited to, soy bean, black bean, green bean, small red bean or sword bean.

In another embodiment, the reconstituted grain product of the present invention further comprises additives. The additives can be nutrient-enhancing agents such as calcium, iron, or texture modifier such as emulsifier or phosphate.

The “various cooking requirements” for these grains and legumes include, but are not limited to, high-pressure cooking, long-time soaking before regular cooking, swelling by soaking or freezing before regular cooking, or pressing pretreatment. The related pretreatment of above mentioned treatment is also included.

In another aspect of the present invention, the method for manufacturing a reconstituted grain product comprises grinding a plurality of materials selected from a group consisting of grains and legumes to be a ground material with between 80˜200 meshes, and subjecting the ground material to mixing, water-adding, extrusion, forming and drying to yield a reconstituted grain product in the form of a rice grain shape.

Preferably, the ground material of the reconstituted grain product in the present invention is between 100˜200 meshes.

In one preferred embodiment, the grains include, but are not limited to, rice, barley, oats, buckwheat, adlay, millet, sorghum, sweet corn, wheat, rye, brown rice or bran; rice includes non-glutinous long-grain indica, non-glutinous short-grain japonica and glutinous rice. Among these, rice is about 10˜90% by weight of the ground material, preferably about 25% by weight. Barley, oat, buckwheat, adlay, millet, sorghum, sweet corn, wheat, or rye is 1˜50% by weight of the ground material respectively. Preferably, barley is about 17.5% by weight of the ground material, oats is about 17.5% by weight, buckwheat is 17.5% by weight, adlay is 17.5% by weight. Rice bran is 1˜10% by weight of the ground material, preferably about 5% by weight. The legumes in the present invention include, but are not limited to, soy bean, black bean, green bean, small red bean or sword bean.

The water content of the ground material after the steps of mixing and water-adding is about 20˜50% by weight, preferably 29-39% by weight.

The steps of “extrusion and forming” can be accomplished by methods commonly used in the art. For example, the ground material can be either pressed into a band or sliced into a strip, then forming a rice grain-shape product. Alternatively, tableting process may be applied.

The step of “extrusion” in the present invention is performed at 50˜110° C. for 1˜3 minutes, preferably at 50˜150° C. for 1˜3 minutes.

The step of “forming” in the present invention further comprises passing the ground material through an 8-pore rice grain-shape die exit and shaping the product by a cutting machine. The rotation speed of the cutting machine is about 400˜3000 rpm, preferably 500˜1500 rpm.

The step of “drying” in the present invention is performed at 45˜50° C. for 3˜4 hours.

The reconstituted grain product in the present invention has several advantages. First, the reconstituted grain product is easy to cook since long-time soaking before cooking is unnecessary. The cooking condition and process are the same as household rice cooking. Cooking can be accomplished for the reconstituted grain product with or without pre-soaking. Second, the reconstituted grain product solves the problems of different cooking condition for various grains and legumes. In addition, the softness, springiness, and moistness of the cooked reconstituted grain product are similar to rice. Moreover, the product of the present invention is enriched with the attributes and properties of various grains and legumes since the present invention reconstitutes various grains and legumes. An additive or dietary supplement can also be added to enhance or balance nutritional value of the product.

### BRIEF DESCRIPTION OF THE DRAWINGS

The present invention will be more fully understood and further advantages will become apparent when reference is made to the following description of the invention and the accompanying drawings in which:

FIG. 1 is a photograph showing the reconstituted grain product of the present invention.

### DETAILED DESCRIPTION OF THE INVENTION

Without intending to limit it in any manner, the present invention will be further illustrated by the following description.

Preparation of the Reconstituted Grain Product

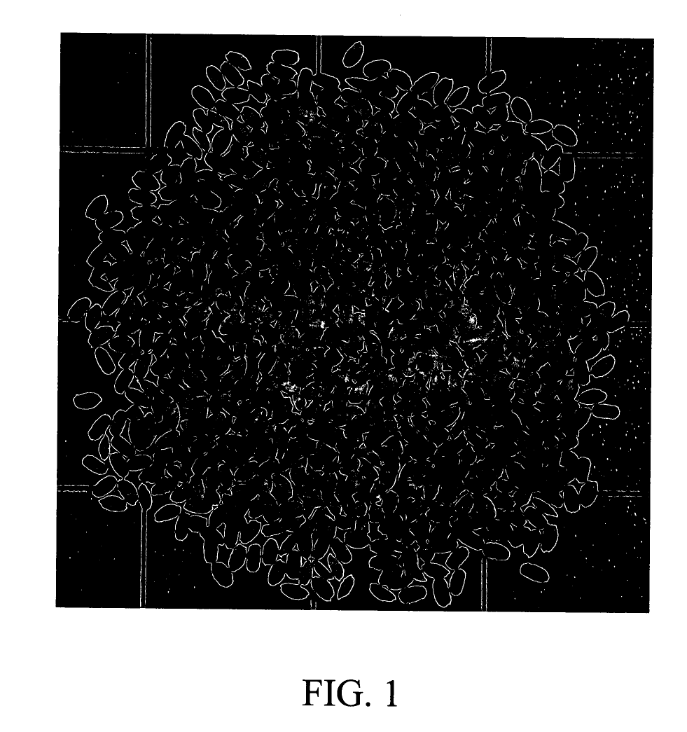

25% by weight of non-glutinous long-grain indica rice, 17.5% by weight of barley, 17.5% by weight of oat,. 17.5% by weight of buckwheat, 17.5% by weight of adlay, and 5% by weight of rice bran were evenly mixed and fed in a barrel of a JSW extrusion machine. The rotation rate of the feeding machine was 30 rpm for the material loading, and 20 rpm for water loading (16˜24%) with 3˜5 sets of kneading element. The barrel was retained at 50˜110° C. when the rotation rate of the screw was 80 rpm, and the mixture exit an 8-pore rice grain-shape die. Shaping was performed by a 6-piece cutting machine with a rotation rate of 500˜1500 rpm. The product was dried at 45˜50° C. for 3˜4 hours (Aw<0.6). The product was cooled and packaged. The obtained reconstituted grain products are shown as FIG. 1.

Cooking Conditions for the Reconstituted Grain Product of the Present Invention

The reconstituted grain product and rice are mixed at 1:1, and an equal volume of water is added into the mixture. Cooking conditions are the same as those of rice, and an electric rice cooker can be used.

Soaking of the reconstituted grain product before cooking is optional. In addition, the softness, springiness, and moistness of the cooked reconstituted grain product are similar to rice irrespective of the nature of constituent grains and legumes. Moreover, the product can in addition comprise additives or dietary supplement to enhance or balance nutritional value of the product.

While the invention has been particularly shown and described with the reference to the preferred embodiments thereof, it will be understood by those skilled in the art that various changes in form and details may be made without departing from the spirit and scope of the invention.

What is claimed is:

1. A reconstituted grain product, manufactured by reconstituting a ground material, wherein the ground material comprises a plurality of grains and legumes having various respective cooking requirements.

2. The reconstituted grain product as claimed in claim 1, wherein the ground material is between 80˜200 meshes.

3. The reconstituted grain product as claimed in claim 2, wherein the ground material is between 100˜200 meshes.

4. The reconstituted grain product as claimed in claim 1, wherein grains used comprise at least one of rice, barley, oat, buckwheat, adlay, millet, sorghum, sweet corn, wheat, rye, or rice bran.

5. The reconstituted grain product as claimed in claim 4, wherein the rice of the ground material is about 10˜90% by weight.

6. The reconstituted grain product as claimed in claim 5, wherein the rice of the ground material is about 25% by weight.

7. The reconstituted grain product as claimed in claim 4, wherein the grains of the ground material, except for rice and rice bran, are 1˜50% by weight respectively.

8. The reconstituted grain product as claimed in claim 7, wherein the barley of the ground material is about 17.5% by weight.

9. The reconstituted grain product as claimed in claim 7, wherein the oats of the ground material are about 17.5% by weight.

10. The reconstituted grain product as claimed in claim 7, wherein the buckwheat of the ground material is about 17.5% by weight.

11. The reconstituted grain product as claimed in claim 7, wherein the adlay of the ground material are about 17.5% by weight.

12. The reconstituted grain product as claimed in claim 4, wherein the rice bran of the ground material is about 1˜10% by weight.

13. The reconstituted grain product as claimed in claim 7, wherein the rice bran of the ground material is about 5% by weight.

14. The reconstituted grain product as claimed in claim 1, wherein the legumes used comprise at least one of soy bean, black bean, green bean, small red bean, or sword bean.

15. The reconstituted grain product as claimed in claim 1, further comprises a nutrient-enhanced agent or a texture modifier.
